(19) United States
(12) Patent Application Publication
(10) Pub. No.: US 2011/0217585 A1
(43) Pub. Date: Sep. 8, 2011

(54) INTEGRATED COMPOSITE SEPARATOR FOR LITHIUM-ION BATTERIES

(75) Inventors: Connie P. Wang, Mountain View, CA (US); Robert Z. Bachrach, Burlingame, CA (US); Sergey D. Lopatin, Morgan Hill, CA (US); Donald J.K. Olgado, Palo Alto, CA (US); Michael C. Kutney, Santa Clara, CA (US); Zheng Wang, Mountain View, CA (US)

(73) Assignee: APPLIED MATERIALS, INC., Santa Clara, CA (US)

(21) Appl. No.: 12/895,483

(22) Filed: Sep. 30, 2010

Related U.S. Application Data
(60) Provisional application No. 61/309,689, filed on Mar. 2, 2010.

(51) Int. Cl. H01M 2/16; B05D 5/12; B05B 5/16

(52) U.S. Cl. 429/145; 427/486; 118/620

(57) ABSTRACT

Embodiments of the present invention relate generally to lithium-ion batteries, and more specifically, to batteries having integrated separators and methods of fabricating such batteries. In one embodiment, a lithium-ion battery having an electrode structure is provided. The lithium-ion battery comprises an anode stack, a cathode stack, and an integrated separator formed between the anode stack and the cathode stack. The anode stack comprises an anodic current collector and an anode structure formed over a first surface of the anodic current collector. The cathode stack comprises a cathodic current collector and a cathode structure formed over a first surface of the cathodic current collector. The integrated separator comprises a first ceramic layer, a second ceramic layer, and a polymer material layer deposited between the first ceramic layer and the second ceramic layer.

### CROSS-REFERENCE TO RELATED APPLICATIONS

This application claims benefit of U.S. provisional patent application Ser. No. 61/309,689 (Attorney Docket No. 14007L), filed Mar. 2, 2010, which is herein incorporated by reference in its entirety.

### BACKGROUND OF THE INVENTION

1. Field of the Invention

Embodiments of the present invention relate generally to lithium-ion batteries, and more specifically, to batteries having integrated separators and methods of fabricating such batteries.

2. Description of the Related Art

Fast-charging, high-capacity energy storage devices, such as supercapacitors and lithium-(Li) ion batteries, are used in a growing number of applications, including portable electronics, medical, transportation, grid-connected large energy storage, renewable energy storage, and uninterruptible power supply (UPS). Li-ion batteries generally comprise a positive current collector with a positive electrode formed thereon, a negative current collector with a negative electrode formed thereon, and a separator formed between the positive electrode and the negative electrode.

The separator is an electronic insulator which provides physical separation between the cathode and the anode electrodes of the Li-ion battery. The separator is typically made from microporous polyethylene and polyolefine. During electrochemical reactions, i.e., charging and discharging, Li-ions are transported through the pores in the separator between the two electrodes. Thus, high porosity is desirable to increase ionic conductivity. However, some high porosity separators are susceptible to electrical shorts when Li dendrites formed during cycling create shorts between the electrodes.

Currently, battery cell manufacturers purchase separators, which are then laminated together with anode and cathode electrodes in separate manufacturing steps. The separator is one of the most expensive components in the Li-ion battery and accounts for over 20% of the material cost in battery cells.

For most energy storage applications, the charge time and capacity of energy storage devices are important parameters. In addition, the size, weight, and/or expense of such energy storage devices can be significant limitations. The use of current separators has a number of drawbacks. Namely, such materials limit the minimum size of the electrodes constructed from such materials, suffer from electrical shorts, and require complex manufacturing methods.

Accordingly, there is a need in the art for faster charging, higher capacity energy storage devices with separators that are smaller, lighter, and can be more cost effectively manufactured.

### SUMMARY OF THE INVENTION

Embodiments of the present invention relate generally to lithium-ion batteries, and more specifically, to batteries having integrated separators and methods of fabricating such batteries. In one embodiment, a lithium-ion battery having an electrode structure is provided. The lithium-ion battery comprises an anode stack, a cathode stack, and an integrated separator formed between the anode stack and the cathode stack. The anode stack comprises an anodic current collector and an anode structure formed over a first surface of the anodic current collector. The cathode stack comprises a cathodic current collector and a cathode structure formed over a first surface of the cathodic current collector. The integrated separator comprises a first ceramic layer, a second ceramic layer, and a polymer material layer deposited between the first ceramic layer and the second ceramic layer.

In another embodiment, a method of forming an electrode structure is provided. The method comprises forming a first electrode structure and electrospraying a first ceramic separator directly onto a surface of the first electrode structure.

In yet another embodiment, a substrate processing system for processing an integrated separator over a flexible conductive substrate is provided. The substrate processing system comprises a first spray coating chamber configured to deposit a first portion of a ceramic separator over the flexible conductive substrate, a second spray coating chamber configured to deposit a second portion of the ceramic separator over the over the flexible conductive substrate, an inkjet chamber configured to deposit a polymer material layer over the ceramic separator, and a substrate transfer mechanism configured to transfer the flexible conductive substrate among the chambers. The substrate transfer mechanism comprising a feed roll disposed out side a processing volume of each chamber and configured to retain a portion of the flexible conductive substrate within the processing volume of each chamber and a take up roll disposed out side the processing volume and configured to retain a portion of the flexible conductive substrate, wherein the substrate transfer mechanism is configured to activate the feed rolls and the take up rolls to move the flexible conductive substrate in and out each chamber, and hold the one or more flexible conductive substrates in the processing volume of each chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The patent or application file contains at least one drawing executed in color. Copies of this patent or patent application publication with color drawings(s) will be provided by the Office upon request and payment of the necessary fee.

FIG. 1 is a schematic diagram of a Li-ion battery cell bi-layer electrically connected to a load according to embodiments described herein;

FIG. 2 is a schematic diagram of a cross-sectional view of one embodiment of a cathode stack and an anode stack prior to integrated separator formation according to embodiments described herein;

FIG. 3 is a process flow chart summarizing one embodiment of a method for forming the cathode stack and the anode stack of FIG. 2 according to embodiments described herein;

FIG. 4A is a schematic diagram of a cross-sectional view of one embodiment of a cathode stack and an anode stack prior to interdigitated separator formation according to embodiments described herein;

FIG. 4B is a schematic diagram of a cross-sectional view of one embodiment of the cathode stack and the anode stack after formation of the interdigitated separator according to embodiments described herein;

FIG. 5 is a process flow chart summarizing one embodiment of a method for forming the cathode stack and the anode stack with the interdigitated separator of FIG. 4B according to embodiments described herein;

FIG. 6 is schematic diagram of a cross-sectional view of one embodiment of a cathode stack with an integrated separated deposited thereon and an anode stack according to embodiments described herein;

FIG. 7 is a process flow chart summarizing one embodiment of a method for forming an electrode structure with an integrated separator according to embodiments described herein;

FIG. 8A is a schematic diagram of a cross-sectional view of one embodiment of an electrode structure with an integrated composite multi-layer separator according to embodiments described herein;

FIG. 8B is a schematic diagram of a top view of one embodiment of a polymer layer of the electrode structure of FIG. 8A;

FIG. 8C is a schematic diagram of a top view of another embodiment of a polymer layer of the electrode structure of FIG. 8A;

FIG. 9 schematically illustrates one embodiment of a vertical processing system according to embodiments described herein;

FIG. 10A is a schematic representation of a scanning electron microscope (SEM) image top view of one embodiment of a polymer layer formed over a graphite electrode according to embodiments described herein;

FIG. 10B is a schematic representation of a scanning electron microscope (SEM) image top view of one embodiment of the polymer layer formed over a graphite electrode according to embodiments described herein;

FIG. 11A is a schematic representation of a scanning electron microscope (SEM) image side view of one embodiment of the polymer layer formed over a graphite electrode according to embodiments described herein;

FIG. 11B is a schematic representation of a scanning electron microscope (SEM) image side view of one embodiment of the ceramic layer formed according to embodiments described herein;

FIG. 12 is a schematic representation of one embodiment of a scanning electron microscope (SEM) image of electrospun polymer fibers;

FIG. 13 is a schematic diagram of an electrode foil divided using printed exclusion lines to form electrodes for individual batteries; and

FIG. 14 is a schematic diagram of a large format Li-ion cell using printed sensing lines to make circuit connections.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention relate generally to lithium-ion batteries, and more specifically, to batteries having integrated separators and methods of fabricating such batteries. In certain embodiments, the direct deposition of a novel integrated separator stack directly onto battery electrodes is provided. The separator may be either a single layer to achieve low cost or multi-layered to achieve improved performance. In one embodiment, a single layer separator is provided. In one embodiment, the single layer separator comprises a porous polymer. In one embodiment, the single layer separator comprises a porous polymer with ceramic particles deposited in the pores of the porous polymer. In one embodiment, the integrated separator may be an interdigitated separator. In one embodiment, the single layer separator comprises polymer fibers which are directly electrospun onto a cathode and/or anode. In certain embodiments where the polymer is electrospun, the polymer has a random or “spaghetti-like” network. Ceramic particles may be deposited into the pores of the porous “spaghetti-like” network. One example of an electrospun polymer, such as Nylon is shown in FIG. 12. One example of such polymer fibers includes semi-crystalline polyamides, such as Nylon 6.6, which has a melting temperature (Tₘ) of approximately 250° C. Another example is polyvinylidene fluoride (PVDF) fibers with Tₘ of approximately 170° C. Another example is a co-polymer such as PVDF-HFP (polyvinylidene+hexafluoropropene). The coated cathode and anode structures are then laminated together to form a battery cell stack. In one embodiment, the polymer fiber may be printed directly onto the cathode and/or anode. The fiber can be extruded or inkjet printed directly onto the electrode. The cathode and anode structures are then laminated together to form battery cells.

In one embodiment, a single layer separator is formed by directly spraying or coating ceramic particle polymer slurry directly onto an electrode. The ceramic powders may be selected from, for example, SiO₂ (silica), Al₂O₃ (alumina), MgO, and combinations thereof. In certain embodiments, the particles may have a particle size between about 10 nm to about 5 um. In certain embodiments, the ceramic particle slurry may further comprise a binder selected from PVDF, styrene-butadiene (SBR), carboxymethyl cellulose (CMC), and combinations thereof. The cathode and anode structures may then be laminated together to form battery cells.

In one embodiment a multi-layer separator is provided. The multi-layer separator may be formed by coating one of the electrodes (i.e., either the cathode or anode) with a ceramic separator, as described above followed by coating the ceramic separator with a polymer layer as described above. The other electrode (i.e., either the anode or cathode) is coated with a ceramic layer as described above followed by a polymer layer. The coated anode and cathode foils are then laminated together to form battery cells.

In one embodiment a multi-layer separator is provided. The multi-layer separator may be formed by coating one of the electrodes (i.e., either the cathode or anode) with a porous polymer, as described above followed by coating the porous polymer with a ceramic material as described above. The other electrode (i.e., either the anode or cathode) may be coated with a polymer layer as described above followed by a ceramic material. The coated anode and cathode foils are then laminated together to form battery cells.

In another embodiment, the polymer layer comprises a lower melting temperature (Tₘ) polymer. In one embodiment, the lower melting temperature polymer is SBR with Tₘ of about 150° C. Thus, during thermal runaway, the polymer lines are melted and fused together, reducing porosity in the layer and thus slow down Li-ion transport and the associated electrochemical reactions.

In certain embodiments of the multi-layer separator stacks, the thickness of the ceramic layer may range from between about 1 um and about 10 um. In certain embodiments, the multi-layer separator stacks may have a porosity between 40-60% as compared to a solid film formed from the same material. The thickness of the polymer layer may range from between about 0.5 um to about 10 um with a porosity between 40-90%, for example, between about 60-80%. The highly porous polymer layer provides a pathway for electrolyte thus reducing the electrolyte penetration time.

While the particular apparatus in which the embodiments described herein can be practiced is not limited, it is particularly beneficial to practice the embodiments on a web-based roll-to-roll system sold by Applied Materials, Inc., Santa Clara, Calif. Exemplary roll-to-roll and discrete substrate systems on which the embodiments described herein may be practiced are described in further detail in commonly assigned U.S. patent application Ser. No. 12/620,788, (Attorney Docket No. APPM/012922/EES/AEP/ESONG), to Lopatin et al., titled APPARATUS AND METHOD FOR FORMING 3D NANOSTRUCTURE ELECTRODE FOR ELECTROCHEMICAL BATTERY AND CAPACITOR, now published as US 2010/0126849, and commonly assigned U.S. patent application Ser. No. 12/839,051, (Attorney Docket No. APPM/014080/EES/AEP/ESONG), filed Jul. 19, 2010, to Bachrach et al, titled COMPRRESSED POWDER 3D BATTERY ELECTRODE MANUFACTURING, both of which are herein incorporated by reference in their entirety.

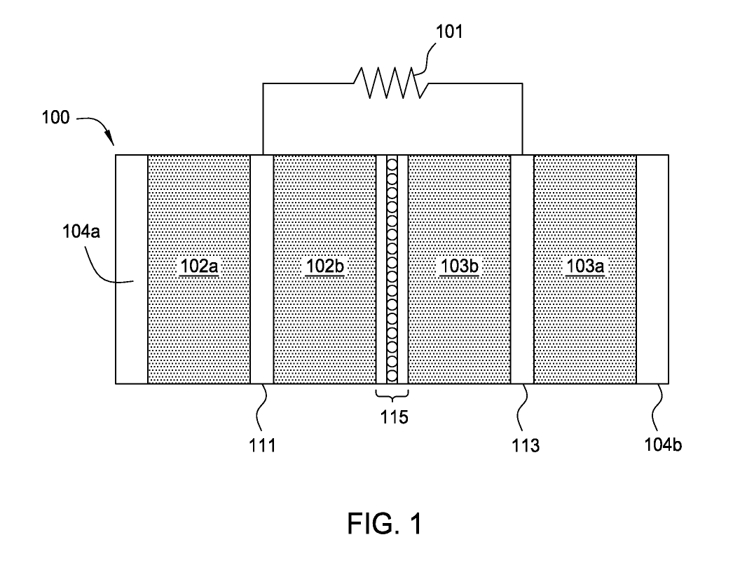

FIG. 1 is a schematic diagram of a partial single sided Li-ion battery cell bi-layer 100 with an integrated separator 115 according to one embodiment described herein. The Li-ion battery cell bi-layer 100 is electrically connected to a load 101, according to one embodiment described herein. The primary functional components of the Li-ion battery cell bi-layer 100 include anode structures 102a, 102b, cathode structures 103a, 103b, separator layers 104a, 104b, current collectors 111 and 113 and an electrolyte (not shown) disposed within the region between the separator layers 104a, 104b. A variety of materials may be used as the electrolyte, for example, a lithium salt in an organic solvent. The Li-ion battery cell 100 is hermetically sealed with electrolyte in a suitable package with leads for the current collectors 111 and 113. The anode structures 102a, 102b, cathode structures 103a, 103b, integrated separator 115, and fluid-permeable separator layers 104a, 104b are immersed in the electrolyte in the region formed between the separator layers 104a and 104b. It should be understood that a partial exemplary structure is shown and that in certain embodiments the separator layers 104a and 104b are replaced with integrated separator layers similar to integrated separator layer 115 followed by corresponding anode structures, cathode structures, and current collectors.

Anode structure 102b and cathode structure 103b serve as a half-cell of Li-ion battery 100. Anode structure 102b includes a metal anodic current collector 111 and a first electrolyte containing material, such as a carbon-based intercalation host material for retaining lithium ions. Similarly, cathode structure 103b includes a cathodic current collector 113 respectively and a second electrolyte containing material, such as a metal oxide, for retaining lithium ions. The current collectors 111 and 113 are made of electrically conductive material such as metals. In one embodiment, the anodic current collector 111 comprises copper and the cathodic current collector 113 comprises aluminum. In certain embodiments, the integrated separator layer 115 is used to prevent direct electrical contact between the components in the anode structure 102b and the cathode structure 103b.

The electrolyte containing porous material on the cathode side of the Li-ion battery 100, or positive electrode, may comprise a lithium-containing metal oxide, such as lithium cobalt dioxide (LiCoO₂) or lithium manganese dioxide (LiMnO₂). The electrolyte containing porous material may be made from a layered oxide, such as lithium cobalt oxide, an olivine, such as lithium iron phosphate, or a spinel, such as lithium manganese oxide. In non-lithium embodiments, an exemplary cathode may be made from TiS₂ (titanium disulfide). Exemplary lithium-containing oxides may be layered, such as lithium cobalt oxide (LiCoO₂), or mixed metal oxides, such as LiNiₓCO₁₋₂xMnO₂, LiNi_{0.5}Mn_{1.5}O₄, Li(Ni_{0.8}CO_{0.15}Al_{0.05})O₂, LiMn₂O₄. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

The electrolyte containing porous material on the anode side of the Li-ion battery 100, or negative electrode, may be made from materials described above, for example, graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material. Exemplary cathode materials, anode materials, and methods of application are further described in commonly assigned U.S. patent application Ser. No. 12/839,051, (Attorney Docket No. APPM/014080/EES/AEP/ESONG), filed Jul. 19, 2010 titled COMPRESSED POWDER 3D BATTERY ELECTRODE MANUFACTURING, and commonly assigned U.S. Provisional Patent Application Ser. No. 61/294,628, (Attorney Docket No. APPM/014493L/LES/AEP/ESONG), filed Jan. 13, 2010, titled GRADED ELECTRODE TECHNOLOGIES FOR HIGH ENERGY LI ION BATTERIES both of which are herein incorporated by reference in their entirety. It should also be understood that although a Li-ion battery cell bi-layer 100 is depicted in FIG. 1, the embodiments described herein are not limited to Li-ion battery cell bi-layer structures. It should also be understood, that the anode and cathode structures may be connected either in series or in parallel.

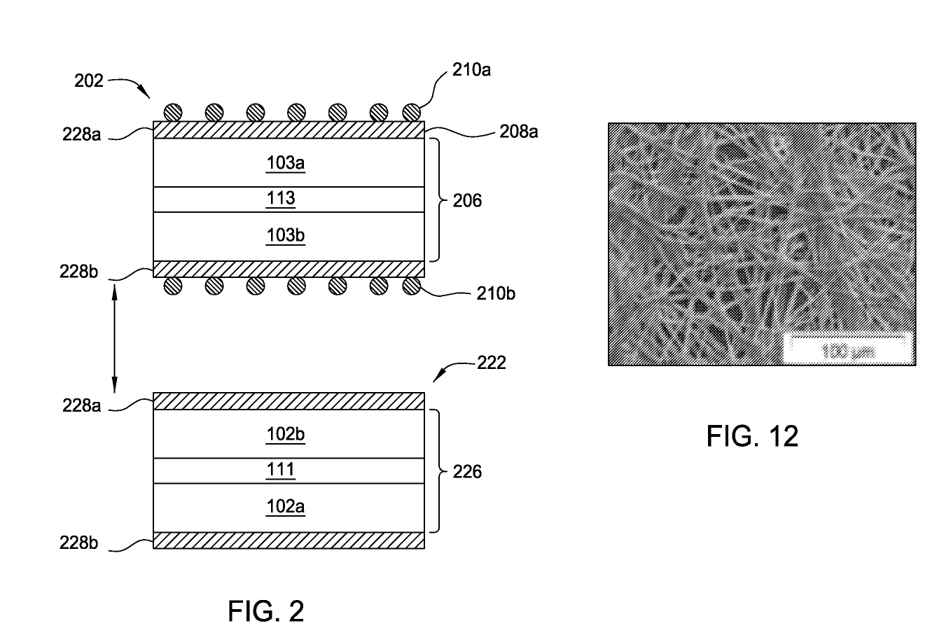

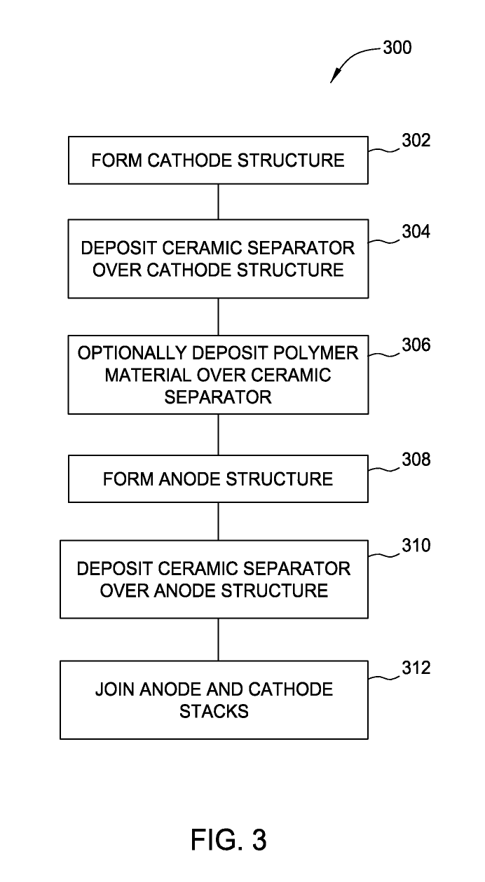

FIG. 2 is a schematic diagram of a cross-sectional view of one embodiment of a cathode stack 202 and an anode stack 222 prior to integrated separator formation according to embodiments described herein. FIG. 3 is a process flow chart summarizing one embodiment of a method 300 for forming the cathode stack 202 and the anode stack 222 of FIG. 2 according to embodiments described herein. In one embodiment, the cathode stack 202 comprises a bi-layer cathode structure 206, ceramic separators 208a, 208b, and polymer material 210a, 210b. At block 302, the bi-layer cathode structure 206 is formed. In one embodiment, the bi-layer cathode structure 206 comprises a first cathode structure 103a, a cathodic current collector 113, and a second cathode structure 103b as depicted in FIG. 2.

The cathode structures 103a, 103b may comprise any structure for retaining lithium ions. In certain embodiments, the cathode structures 103a, 103b have a graded particle size throughout the cathode electrode structure. In certain embodiments, the cathode structures 103a, 103b comprise a multi-layer structure where the layers comprise cathodically active materials having different sizes and/or properties. Exemplary cathode structures are described in commonly assigned U.S. Provisional Patent Application Ser. No. 61/294,628, (Attorney Docket No. APPM/014493L/LES/AEP/ESONG), filed Jan. 13, 2010, titled GRADED ELECTRODE TECHNOLOGIES FOR HIGH ENERGY LI ION BATTERIES which is herein incorporated by reference in its entirety.

In one embodiment, the cathode structures 103a, 103b comprise a porous structure comprising a cathodically active material. In one embodiment, the cathodically active material is selected from the group comprising: lithium cobalt dioxide (LiCoO₂), lithium manganese dioxide (LiMnO₂), titanium disulfide (TiS₂), LiNixCO₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof. In one embodiment, the cathode structures further comprise a binding agent selected from the group comprising: polyvinylidene fluoride (PVDF), carboxymethyl cellulose (CMC), and water-soluble binding agents, such as styrene butadiene rubber (SBR), conductive binder, and other low or no-solvent binders.

In one embodiment, the cathode structure may be applied using powder application techniques including but not limited to sifting techniques, electrostatic spraying techniques, thermal or flame spraying techniques, plasma spraying techniques, fluidized bed coating techniques, slit coating techniques, roll coating techniques, and combinations thereof, all of which are known to those skilled in the art. In certain embodiments, the cathode electrodes have a graded porosity such that the porosity varies throughout the structure of the cathode electrode. In one embodiment, the graded porosity provides for a higher porosity adjacent to the current collector and a lower porosity as the distance from the current collector increases. The higher porosity adjacent to the current collector increases the active surface area of the electrode providing for higher power performance but yielding a lower voltage electrode whereas the lower porosity provides for a higher voltage electrode with slower power performance. In another embodiment, the graded porosity provides for a lower porosity adjacent to the current collector and a higher porosity as the distance from the current collector increases. In certain embodiments, where a dual-sided electrode is formed, such as the bi-layer cathode structure 206 depicted in FIG. 2, the cathode structure 103a and the cathode structure 103b may be simultaneously deposited on opposing sides of the cathodic current collector 113 using a dual-sided deposition process. For example, a dual-sided electrostatic spraying process which uses opposing spray applicators to deposit cathodically active material on opposing sides of the substrate.

At block 304, ceramic separators 208a, 208b are deposited over the bi-layer cathode structure 206. In one embodiment, the ceramic separators 208a, 208b are formed by directly spraying or coating ceramic particle polymer slurry directly onto a surface of the cathode structures 103a, 103b. In one embodiment, the ceramic particles may be selected from the group comprising: Pb(Zr,Ti)O₃ (PZT), Pb₁₋ₓLaₓZr_{1-y}Ti_{y}O₃ (PLZT, x and y are independently between 0 and 1), PB(Mg₃Nb_{2/3})O₃—PbTiO₃ (PMN-PT), BaTiO₃, HfO₂ (hafnia), SrTiO₃, TiO₂ (titania), SiO₂ (silica), Al₂O₃ (alumina), ZrO₂ (zirconia), SnO₂, CeO₂, MgO, CaO, Y₂O₃ and combinations thereof. In one embodiment, the ceramic particles are selected from the group comprising SiO₂, Al₂O₃, MgO, and combinations thereof. In certain embodiments, the particles may have a particle size between about 50 nm to about 0.5 um. The small particle size of the ceramic particles makes it more difficult for lithium dendrites formed during the cycling process from growing through the separator and causing shorts. In certain embodiments, the ceramic particle slurry may further comprise a binder selected from PVDF, carboxymethyl cellulose (CMC), and styrene-butadiene (SBR). In one embodiment, the ceramic separators 208a, 208b comprise about 10-60 wt % binder with the remainder being ceramic particles. In one embodiment, the ceramic separators 208a, 208b have a thickness between about 1 μm to about 20 μm.

In one embodiment, the ceramic separators are applied as a powder using powder application techniques including but not limited to sifting techniques, electrostatic spraying techniques, thermal or flame spraying techniques, plasma spraying techniques, fluidized bed coating techniques, slit coating techniques, roll coating techniques, and combinations thereof, all of which are known to those skilled in the art. In one embodiment, it is preferable to spray the ceramic separators directly on the electrodes. Whereas application processes such as the Doctor Blade process produce conformal deposition over defects present in previous layers, the spray process fills in around such defects thus producing a more planar surface. In one embodiment, the spray process is a semi-dry spray process where the substrate is heated prior to the spray process to facilitate drying of each layer as it is deposited. In certain embodiments, ceramic separators 208a, 208b may be simultaneously deposited on opposing sides of the bi-layer cathode structure 206 using a dual-sided deposition process, for example, an electrostatic spray process.

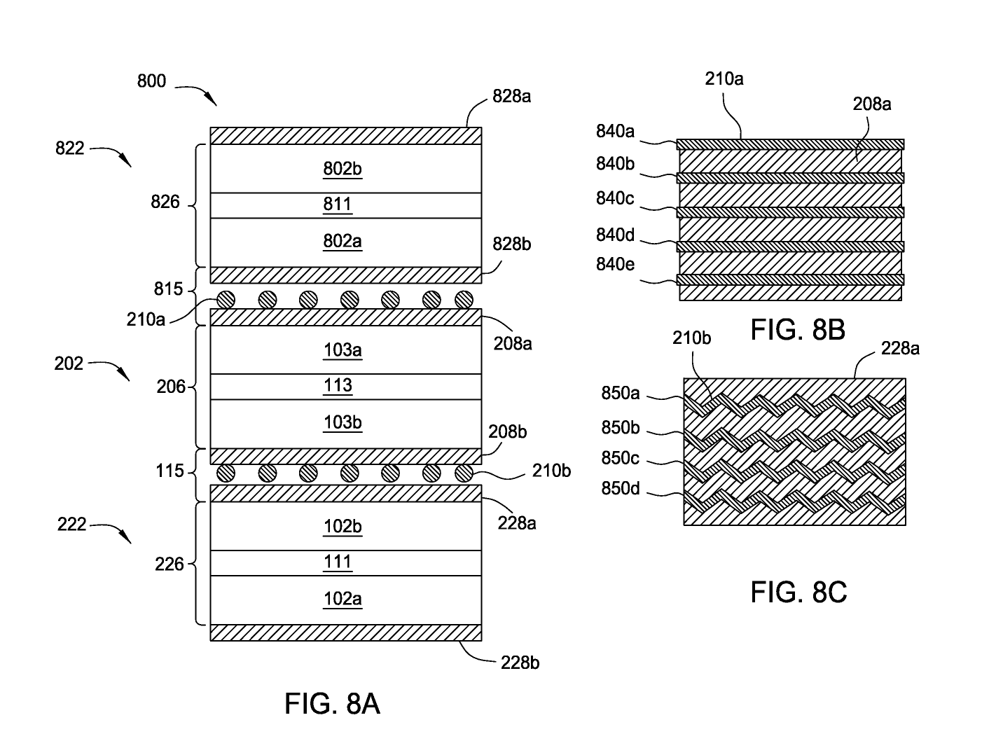

At block 306, optional polymer material layers 210a, 210b are deposited over ceramic separators 208a, 208b. In one embodiment, the polymer material layers are deposited as a series of polymer lines with interspersed channels formed in between adjacent lines (See FIGS. 8B and 8C). In one embodiment, each polymer line has a width between about 0.5 μm and about 10 μm. In one embodiment, the polymer material layers 210a, 210b have an average height between about 1 μm and about 10 μm. In one embodiment, the polymer material layers 210a, 210b each have a porosity between about 40% to about 80%. In another embodiment, the polymer material layers 210a, 210b have a porosity between about 60% to about 80%. The interspersed channels advantageously allow for electrolyte to quickly penetrate from the edge of the electrode into the battery cell.

In one embodiment, the polymer layer comprises a lower melting temperature polymer, such as SBR with Tₘ, of about 150° C. Thus, during thermal runaway, the polymer lines are melted and fused together, reducing porosity in the layer and thus slow down Li-ion transport and the associated electrochemical reactions. In certain embodiments, the polymer layer further comprises ceramic particles embedded in the polymer layer. The ceramic particles may be selected from the same group of ceramic particles used to form the ceramic layers 208a, 208b. In one embodiment, the polymer layer comprises a co-polymer such as PVDF-HFP. It should be understood that although the polymer material layers 210a, 210b are deposited as part of the cathode stack 202, in certain embodiments, it may be desirable instead to form the polymer material layers over the anode stack 222 rather than the cathode stack 202. It should also be understood that in certain embodiments, it is desirable to deposit the polymer material layers 210a, 210b directly onto the surface of either the anode structure of the cathode structure without the use of the ceramic separator.

The polymer material layers 210a, 210b may be deposited using techniques such as electrospinning techniques, inkjet techniques, or co-extrusion techniques.

The polymer material may be selected from the group of: carboxymethyl cellulose (CMC), Polyacrylic acid (PAA), Polyethylene (PE), Polyethylene terephthalate (PETE), Polyolefin, Polyphenyl ether (PPE), Polyvinyl chloride (PVC), Polyvinylidene chloride (PVDC), Polyvinylidene fluoride (PVDF), Poly(vinylidenefluoride-co-hexafluoropropylene (PVDF-HFP), Polylactic acid (PLA), Polypropylene (PP), Polybutylene (PB), Polybutylene terephthalate (PBT), Polyamide (PA), Polyimide (PI), Polycarbonate (PC), Polytetrafluoroethylene (PTFE), Polystyrene (PS), Polyester (PE), Acrylonitrile butadiene styrene (ABS), Poly(methyl methacrylate) (PMMA), Polyoxymethylene (POM), Polysulfone (PES), Styrene-acrylonitrile (SAN), Styrene-butadiene rubber (SBR), Ethylene vinyl acetate (EVA), Styrene maleic anhydride (SMA), and combinations thereof.

At block 308, an anode stack 222 is formed. In one embodiment, the anode stack 222 comprises a bi-layer anode structure 226 and ceramic separators 228a, 228b. In one embodiment, the bi-layer anode structure 226 comprises a first anode structure 102a, an anodic current collector 111, and a second anode structure 102b as depicted in FIG. 2.

In one embodiment, the anode structures 102a, 102b may be carbon based porous structure, either graphite or hard carbon, with particle sizes around 5-15 um. In one embodiment, the lithium-intercalation carbon anode is dispersed in a matrix of polymeric binding agent. Carbon black may be added to enhance power performance. The polymers for the binding agent matrix are made of thermoplastic or other polymers including polymers with rubber elasticity. The polymeric binding agent serves to bind together the active material powders to preclude crack formation and promote adhesion to the collector foil. The quantity of polymeric binding agent is in the range of 1% to 40% by weight. The electrolyte containing porous material of the anode structures 102a, 102b may be made from materials described above, for example, graphitic particles dispersed in a polymer matrix and/or various fine powders, for example, micro-scale or nano-scale sized powders. Additionally, microbeads of silicon, tin, or lithium titanate (Li₄Ti₅O₁₂) may be used with, or instead of, graphitic microbeads to provide the conductive core anode material.

In one embodiment, the anode structures comprise conductive microstructures formed as a three dimensional, columnar growth of material by use of a high plating rate electroplating process performed at current densities above the limiting current (i_{L}). The diffusion-limited electrochemical plating process by which conductive microstructures in which the electro-plating limiting current is met or exceeded, thereby producing a low-density metallic meso-porous/columnar structure rather than a conventional high-density conformal film. Different configurations of conductive microstructures are contemplated by embodiments described herein. The conductive microstructures may comprise materials selected from the group comprising copper, tin, silicon, cobalt, titanium, alloys thereof, and combinations thereof. Exemplary plating solutions and process conditions for formation of the conductive microstructures are described in commonly assigned U.S. patent application Ser. No. 12/696,422, filed Jan. 29, 2010, to Lopatin et al., titled POROUS THREE DIMENSIONAL COPPER, TIN, COPPER-TIN, COPPER-TIN-COBALT, AND COPPER-TIN-COBALT-TITANIUM ELECTRODES FOR BATTERIES AND ULTRA CAPACITORS, which is herein incorporated by reference in its entirety.

In one embodiment, the current collectors 111 and 113 may comprise a material individually selected from the group comprising aluminum (Al), copper (Cu), zinc (Zn), nickel (Ni), cobalt (Co), tin (Sn), silicon (Si), manganese (Mn), magnesium (Mg), alloys thereof, and combinations thereof. In one embodiment, the cathodic current collector 113 is aluminum and the anodic current collector 111 is copper. Examples of materials for the positive current collector 113 (the cathode) include aluminum, stainless steel, and nickel. Examples of materials for the negative current collector 111 (the anode) include copper (Cu), stainless steel, and nickel (Ni). Such collectors can be in the form of a foil, a film, or a thin plate. In certain embodiments, the collectors have a thickness that generally ranges from about 5 to about 50 μm.

At block 310, ceramic separators 228a, 228b are deposited over the bi-layer anode structure 226. The ceramic separators 228a, 228b may be formed using the techniques described above for forming separators 208a, 208b. It should be understood that in certain embodiments, the cathode stack 202 and the anode stack are formed simultaneously in separate processes prior to being joined together.

At block 312, the cathode stack 202 and the anode stack 222 are joined together. In one embodiment, the cathode stack 202 and the anode stack 222 may be packaged using a lamination process with a packaging film-foil, such as, for example, an Al/Al₂O₃ foil.

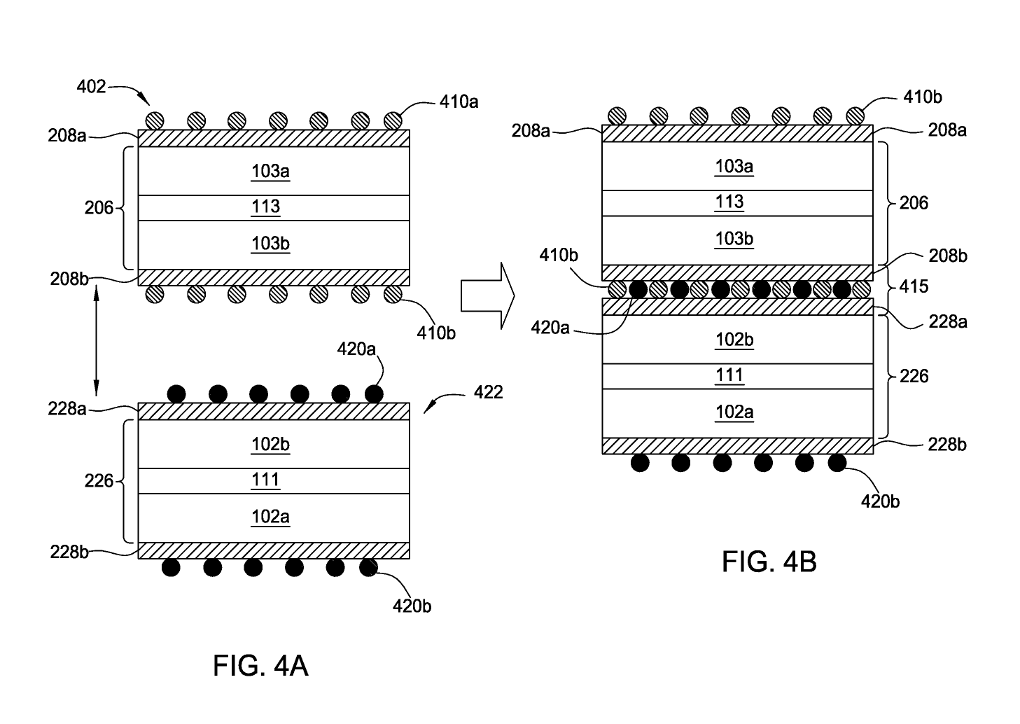

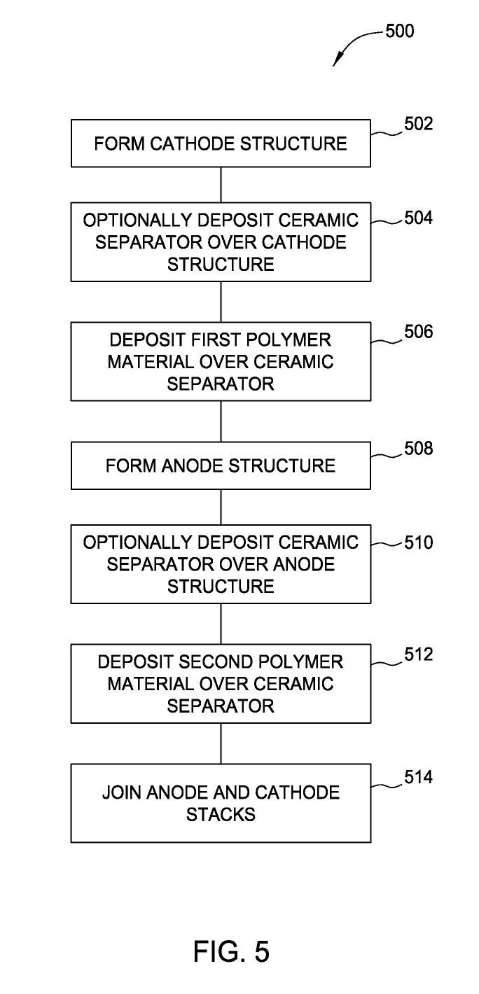

FIG. 4A is a schematic diagram of a cross-sectional view of a cathode stack 402 and an anode stack 422 prior to formation of an interdigitated separator 415 therebetween according to embodiments described herein. FIG. 4B is a schematic diagram of a cross-sectional view of the cathode stack 402 and the anode stack 422 after formation of the interdigitated separator 415 according to embodiments described herein. FIG. 5 is a process flow chart summarizing one embodiment of a method 500 for forming the cathode stack 402 and the anode stack 422 with the interdigitated separator 415 of FIG. 4B according to embodiments described herein.

At block 502, a bi-layer cathode structure 206 is formed. At block 504 ceramic separators 208a, 208b are formed over the cathode structure 206. At block 506, a first polymer material 410a, 410b is deposited over the ceramic separators 208a, 208b. At block 508, a bi-layer anode structure 226 is formed. At block 510, ceramic separators 228a, 228b are formed over the bi-layer anode structure 226. At block 512, a second polymer material 420a, 420b is deposited over the ceramic separators 228a, 228b. At block 514, a cathode stack 402 and an anode stack 422 are joined together to form the battery cell with an interdigitated separator 415. The method 500 is substantially similar to the method 300 described in blocks 302-312 of FIG. 3 except a first polymer material is formed over the ceramic separators of the cathode stack at block 506 and a second polymer material is deposited over the ceramic separators of the anode stack at block 512. When the anode stack and the cathode stack are joined together, an interdigitated separator is formed between the anode stack and the cathode stack.

As shown in FIG. 4B, the interdigitated separator 415 comprises ceramic separator 208b, ceramic separator 228a, first polymer material 410b, and second polymer material 420a. In one embodiment, the first polymer material layer 410b comprises a polymer material having a high melting temperature (Tₘ) (e.g. greater than 200° C.) and the second polymer material layer 420a comprises a polymer material having a low melting temperature (e.g. less than 140° C.). In one embodiment, the first polymer material layer 410b comprises a polymer material having a high melting temperature selected from the group comprising Nylon 6.6. In one embodiment, the second polymer material layer comprises a lower melting temperature polymer, such as SBR with Tₘ of about 150° C. Thus, during thermal runaway, the lower melting temperature polymer lines are melted and fused together, reducing porosity in the layer and thus slow down Li-ion transport and the associated electrochemical reactions. It should be understood that although the interdigitated separator 415 is shown as having ceramic separators 208b, 228a, the interdigitated separator 415 may be formed without the ceramic separators 208b, 228a with the first polymer material 410b deposited directly on the surface of the bi-layer cathode structure 206 and the second polymer material 420a deposited directly on the surface of the bi-layer anode structure 226. In certain embodiments, the first polymer material layers 410a, 410b and/or the second polymer material layers 420a, 420b further comprise ceramic particles embedded in the polymer material layer. In certain embodiments, the first polymer material layers 410a, 410b and/or the second polymer material layers 420a, 420b comprise a co-polymer such as PVDF-HFP. The ceramic particles may be selected from the same group of ceramic particles used to form the ceramic layers 208a, 208b.

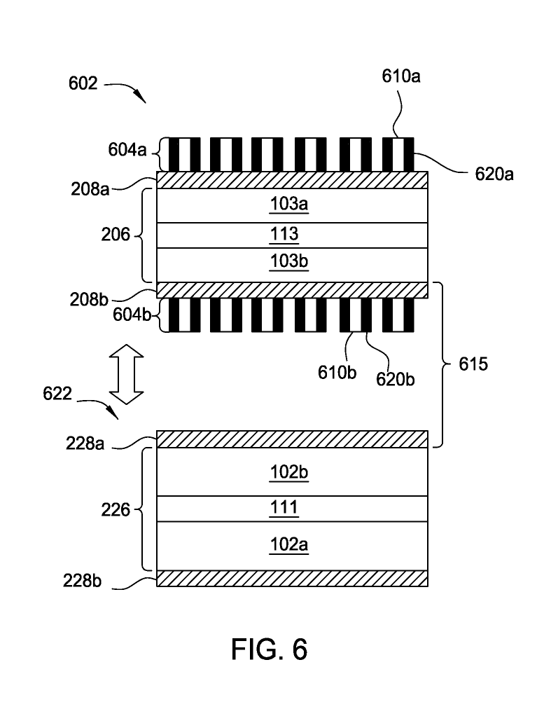

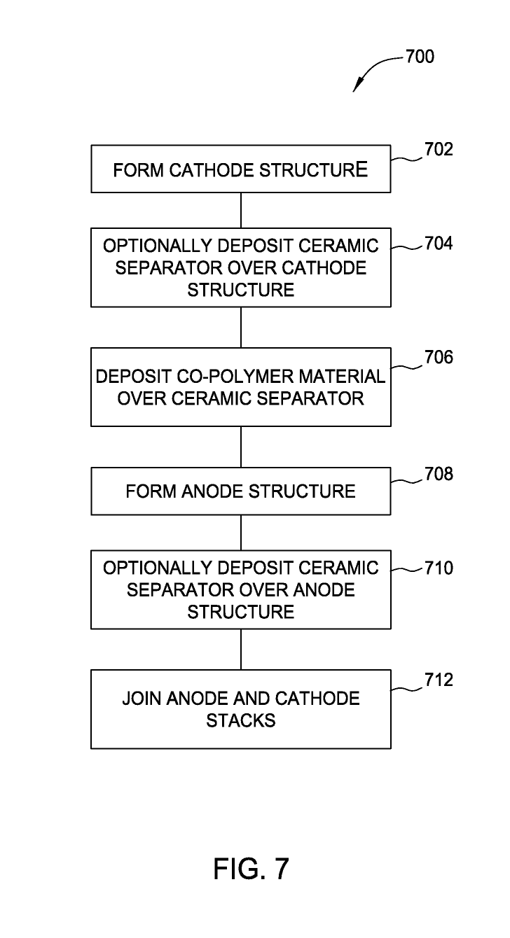

FIG. 6 is schematic diagram of a cross-sectional view of a cathode stack 602 with an integrated separator deposited thereon and an anode stack 622 according to embodiments described herein. FIG. 7 is a process flow chart summarizing one embodiment of a method 700 for forming an electrode structure with an integrated separator according to embodiments described herein.

At block 702a bi-layer cathode structure 206 is formed. At block 704, optionally, ceramic separators 208a, 208b are formed over the cathode structure 206. At block 706, a co-polymer material layer 604a, 604b are formed over the ceramic separators 208a, 208b. At block 708, a bi-layer anode structure 226 is formed. At block 710, optionally, ceramic separators 228a, 228b are formed over the bi-layer anode structure 226. At block 712, the cathode stack 602 and the anode stack 622 are joined together. The method 700 is substantially similar to the method 300 described in blocks 302-312 of FIG. 3 and the method 500 described in blocks 502-514 except that a co-polymer material is deposited over the ceramic separator of the cathode stack at block 706. When joined together, the cathode stack 602 and the anode stack 622 form an integrated separator 615.

In one embodiment, the integrated separator 615 comprises ceramic separator 208b, ceramic separator 228a, and co-polymer layer 604b. In another embodiment, the integrated separator 615 comprises only the co-polymer layer without ceramic separator 208b or ceramic separator 228b and thus the co-polymer layer is deposited directly on the cathode stack 602. The co-polymer layers 604a, 604b comprise a first polymer material 610a, 610b and a second polymer material 620a, 620b. In one embodiment, the co-polymer layers 604a, 604b comprises a co-extrusion polymer where the inner layer or first polymer material 610a, 610b comprises a polymer material having a high melting temperature (Tₘ) (e.g. greater than 200° C.) and the outer layer or second polymer material layer 620a, 620b comprises a polymer material having a low melting temperature (e.g. less than 140° C.). In one embodiment, the first polymer material 610a, 610b comprises a polymer material having a high melting temperature selected from the group comprising Nylon 6.6. In one embodiment, the second polymer material 620a, 620b comprises a lower melting temperature polymer, such as SBR with Tₘ of about 150° C. Thus, during thermal runaway, the lower melting temperature polymer lines are melted and fused together, reducing porosity in the layer and thus slow down Li-ion transport and the associated electrochemical reactions. In one embodiment, the co-polymer layer 604a, 604b may be co-deposited using, for example, an inkjet process. In certain embodiments, the first polymer material layers 610a, 610b and/or the second polymer material layers 620a, 620b further comprise ceramic particles embedded in the polymer material layer. In certain embodiments, the first polymer material layers 610a, 610b and/or the second polymer material layers 620a, 620b comprise a co-polymer such as PVDF-HFP. The ceramic particles may be selected from the same group of ceramic particles used to form the ceramic layers 208a, 208b.

FIG. 8A is a schematic diagram of a cross-sectional view of an electrode structure 800 with integrated composite multi-layer separators 115, 815 according to embodiments described herein. The electrode structure 800 comprises a cathode stack 202, a first anode stack 222, and a second anode stack 822. The cathode stack 202 and the first anode stack 222 are described above with reference to FIG. 2. The second anode stack 822 is similar to first anode stack 222. The second anode stack 822 comprises a bi-layer anode structure 826 and ceramic separators 828a, 828b. In one embodiment, the bi-layer anode structure 826 comprises a first anode structure 802a, a current collector 811, and a second anode structure 802b as depicted in FIG. 2. Integrated separator 115 is formed when the cathode stack 202 and the first anode stack 222 are joined together. Integrated separator 815 is formed when the second anode stack 822 and the cathode stack 202 are joined together.

FIG. 8B is a schematic diagram of a top view of one embodiment of the polymer layer 210a formed over the ceramic separator 208a of the electrode structure 800 of FIG. 8A. As shown in FIG. 8B, the polymer layer 210a may be deposited in a parallel line design with channels formed in between each line 840a-840e to allow for the flow of electrolyte. In one embodiment, the polymer material layers are deposited as a series of polymer lines with interspersed channels formed in between adjacent lines (See FIGS. 8B and 8C). In one embodiment, each polymer line 840a-840e has a width between about 0.5 μm and about 10 μm.

FIG. 8C is a schematic diagram of a top view of another embodiment of a polymer layer 210b of the electrode structure 800 of FIG. 8A. As shown in FIG. 8C, the polymer layer 210b may be deposited in a zig-zag pattern with spaces in between each line 850a-850d to allow for the flow of electrolyte. It should be understood that the embodiments described herein are not limited to either the parallel line design or the zig-zag design. Any pattern which achieves desired porosity while maintaining structural integrity may be used. As discussed above, the polymer layers 210a and 210b may be deposited using processes such as electrospinning, inkjet, and co-extrusion.

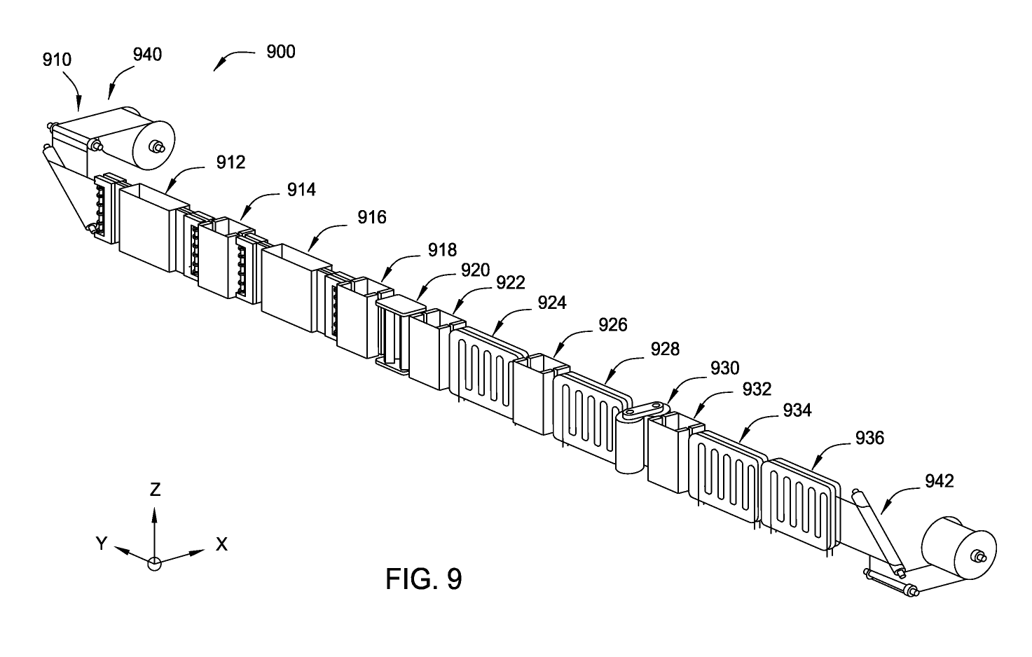

FIG. 9 schematically illustrates one embodiment of a vertical processing system 900 according to embodiments described herein. The processing system 900 generally comprises a plurality of processing chambers 912-934 arranged in a line, each configured to perform one processing step to a vertically positioned flexible conductive substrate 910. In one embodiment, the processing chambers 912-934 are stand alone modular processing chambers wherein each modular processing chamber is structurally separated from the other modular processing chambers. Therefore, each of the stand alone modular processing chambers, can be arranged, rearranged, replaced, or maintained independently without affecting each other. In one embodiment, the processing chambers 912-934 are configured to perform a simultaneous two sided process to simultaneously process each side of the flexible conductive substrate 910.

In one embodiment, the processing system 900 comprises a microstructure formation chamber 912. In one embodiment, the microstructure formation chamber is selected from a plating chamber, an imprint chamber, an embossing chamber, and an electrochemical etching chamber. In one embodiment, the microstructure formation chamber 912 is an imprint chamber configured to perform an imprinting process on at least a portion of the flexible conductive substrate 910 to form a porous flexible conductive substrate.

In one embodiment, the processing system 900 further comprises a first rinse chamber 914 configured to rinse and remove any residual particles and processing solution from the portion of the vertically oriented conductive flexible substrate 910 with a rinsing fluid, for example, de-ionized water, after the imprinting process.

In one embodiment, the processing system 900 further comprises a second microstructure formation chamber 916 disposed next to the first rinse chamber 914. In one embodiment, the second microstructure formation chamber 916 is configured to perform an etching process on at least a portion of the flexible conductive substrate 910 to form the porous flexible conductive substrate. In one embodiment, chamber 912 and chamber 916 may individually comprise a chamber selected from an imprint chamber, a wet etch chamber, an electrochemical etching chamber, a pattern punch-through chamber, and combinations thereof.

In one embodiment, the processing system 900 further comprises a second rinse chamber 918 configured to rinse and remove any residual etching solution from the portion of the vertically oriented conductive flexible substrate 910 with a rinsing fluid, for example, de-ionized water, after the wet etch process has been performed. In one embodiment, a chamber 920 comprising an air-knife is positioned adjacent to the second rinse chamber 918.

In one embodiment, the processing system 900 further comprises a pre-heating chamber 922 configured to expose the flexible conductive substrate 910 to a drying process to remove excess moisture from the deposited porous structure. In one embodiment, the pre-heating chamber 922 contains a source configured to perform a drying process such as an air drying process, an infrared drying process, an electromagnetic drying process, or a marangoni drying process.

In one embodiment, the processing system 900 further comprises a first spray coating chamber 924 configured to deposit a cathodically active or anodicially active particles, over and/or into the vertically oriented porous conductive substrate 910. Although discussed as a spray coating chamber, the first spray coating chamber 924 may be configured to perform any of the aforementioned deposition processes.

In one embodiment, the processing system 900 further comprises a post-drying chamber 926 disposed adjacent to the first spray coating chamber 924 configured to expose the vertically oriented conductive substrate 910 to a drying process. In one embodiment, the post-drying chamber 926 is configured to perform a drying process such as an air drying process, for example, exposing the conductive substrate 910 to heated nitrogen, an infrared drying process, a marangoni drying process, or an annealing process, for example, a rapid thermal annealing process.

In one embodiment, the processing system 900 further comprises a second spray coating chamber 928 positioned adjacent to the post-drying chamber 926. Although discussed as a spray coating chamber, the second spray coating chamber 928 may be configured to perform any of the aforementioned deposition processes. In one embodiment, the second spray coating chamber is configured to deposit anodically or cathodically active particles, over the vertically oriented porous conductive substrate 910. In one embodiment, the second spray coating chamber 928 is configured to deposit an additive material such as a binder over the vertically oriented conductive substrate 910. In embodiments where a two pass spray coating process is used, the first spray coating chamber 924 may be configured to deposit cathodically active particles over the vertically oriented conductive substrate 910 during a first pass using, for example, an electrostatic spraying process, and the second spray coating chamber 928 may be configured to deposit cathodically active particles over the vertically oriented conductive substrate 910 in a second pass using, for example, a slit coating process.

In one embodiment, the processing system 900 further comprises a compression chamber 930 disposed adjacent to the second spray coating chamber 928 configured to expose the vertically oriented conductive substrate 910 to a calendaring process to compress the as-deposited cathodically active particles into the conductive microstructure. In one embodiment, the compression process may be used to modify the porosity of the as-deposited cathodically active particles to a desired net-density.

In one embodiment, the processing system 900 further comprises a third drying chamber 932 disposed adjacent to the third spray coating chamber 934 configured to expose the vertically oriented conductive substrate 910 to a drying process. In one embodiment, the third drying chamber 932 is configured to expose the vertically oriented conductive substrate 910 to a drying process such as an air drying process, for example, exposing the conductive substrate 910 to heated nitrogen, an infrared drying process, a marangoni drying process, or an annealing process, for example, a rapid thermal annealing process.

In one embodiment, the processing system 900 further comprises a third spray coating chamber 934 positioned adjacent to the third drying chamber 932. Although discussed as a spray coating chamber, the third spray coating chamber 932 may be configured to perform any of the aforementioned deposition processes. In one embodiment, the third spray coating chamber 932 is configured to deposit a portion of a separator layer over the flexible conductive substrate 910.

In one embodiment, the processing system 900 further comprises a fourth spray coating chamber 936 positioned adjacent to the third spray coating chamber 934. Although discussed as a spray coating chamber, the fourth spray coating chamber 936 may be configured to perform any of the aforementioned deposition processes. In one embodiment, the fourth spray coating chamber 936 is configured to deposit a portion of the separator layer over the flexible conductive substrate 910.

In certain embodiments, the processing system 900 further comprises additional processing chambers. The additional modular processing chambers may comprise one or more processing chambers selected from the group of processing chambers comprising an electrochemical plating chamber, an electroless deposition chamber, a chemical vapor deposition chamber, a plasma enhanced chemical vapor deposition chamber, an atomic layer deposition chamber, a rinse chamber, an anneal chamber, a drying chamber, a spray coating chamber, additional spray chamber, polymer deposition chamber and combinations thereof. It should also be understood that additional chambers or fewer chambers may be included in the in-line processing system.

The processing chambers 912-936 are generally arranged along a line so that portions of the vertically oriented conductive substrate 910 can be streamlined through each chamber through feed roll 940 and take up roll 942. In one embodiment, as the vertically oriented substrate 910 leaves the take up roll 942, the substrate 910 is further processed to form a prismatic assembly.

It should also be understood that although discussed as a system for processing a vertically oriented substrate, the same processes may be performed on substrates having different orientations, for example, a horizontal orientation. Details of a horizontal processing system that can be used with the embodiments described herein are disclosed in commonly assigned U.S. patent application Ser. No. 12/620,788, titled APPARATUS AND METHOD FOR FORMING 3D NANOSTRUCTURE ELECTRODE FOR ELECTROCHEMICAL BATTERY AND CAPACITOR, to Lopatin et al., filed Nov. 18, 2009, now published as US2010-0126849 of which FIGS. 5A-5C, 6A-6E, 7A-7C, and 8A-8D and text corresponding to the aforementioned figures are incorporated by reference herein. In certain embodiments, the vertically oriented substrate may be slanted relative to a vertical plane. For example, in certain embodiments, the substrate may be slanted from between about 1 degree to about 20 degrees from the vertical plane.

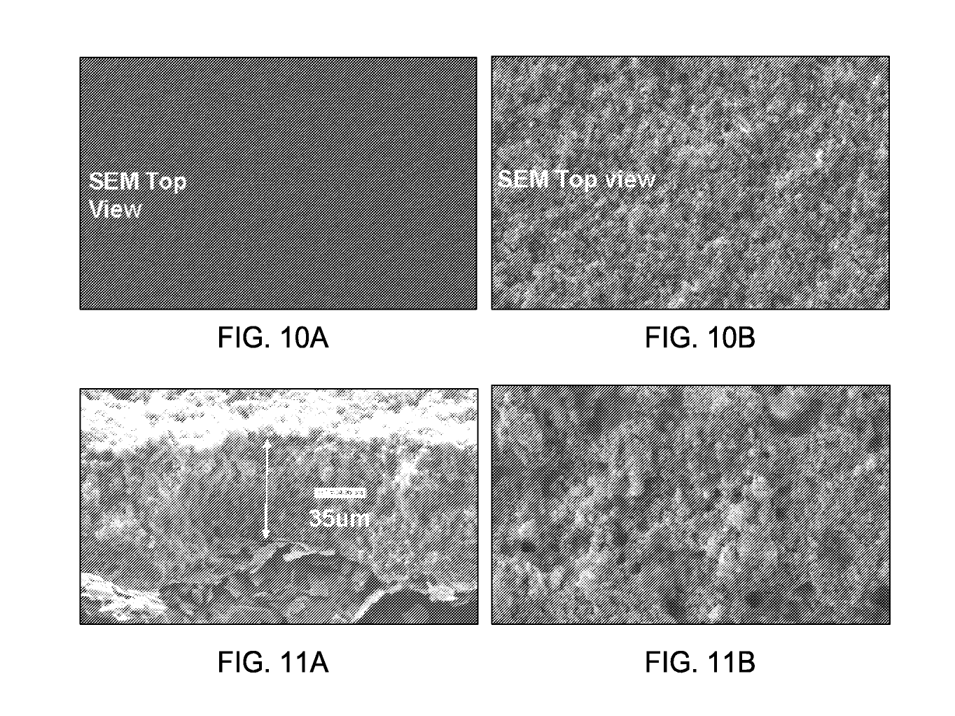

FIGS. 10A and 10B are schematic representations of a scanning electron microscope (SEM) image of one embodiment of a polymer separator layer formed on a graphite electrode according to embodiments described herein. FIGS. 11A and 11B are schematic representations of a scanning electron microscope (SEM) image side view of one embodiment of the polymer separator layer formed over a graphite electrode according to embodiments described herein. The polymer layer comprises SiO₂ (10-20 nm particle size) and SBR in a 1:1 wt % ratio. The polymer layer has a thickness of approximately 35 μm. The polymer layer was formed using a 3-pass electrostatic spraying process. As shown in FIGS. 11A and 11B, there are no obvious signs of SiO₂/binder penetration at the graphite/electrode interface and microporosity is observed in the polymer separator layer.

Embodiments described herein provide a separator having high porosity for good ionic conductivity, complex pore structure to suppress Li short, build-in safety shutdown feature, excellent thermal and mechanical stability and can be produced at low cost.

Li-Ion Battery Electrode with Build-in Functionalities

It is expected that large format Li-ion battery (LIB) will replace Ni-Metal Hydride (NiMH) batteries in hybrid electric vehicles and enable plug-in electric vehicles. LIB has 2 to 3× higher energy density, lower self-discharge rate and higher cell voltage than NiMH batteries. However, some of the key challenges for large format Li-ion batteries include: safety due to uncontrolled thermal runaway, which can be triggered by over-charging, abuses, or localized defects; the inside a large format battery is difficult to monitor; calendar and cycle life to meet 10-15 year warrantee requirement for automobile makers, failure mode includes contact loss in electrodes, especially at elevated temperature (>40 C); high manufacturing cost, especially for large format Li-ion battery.

Currently Li-ion battery electrodes are formed through slurry coating (painting) processes. The slurry comprises electrode particles, binder, carbon additive to improve conductivity, and solvent. The slurry is coated onto a current collector, typically Al or Cu foil, which is then exposed to a slow annealing process to drive out solvent without cracking the coating. A densification process (calendaring) is applied afterward. The electrode-coated foil is then slit into smaller sections to form individual battery cells. The cells are assembled into modules, which are subsequently assembled into a battery pack to meet voltage, power and energy requirements of the specific application. The typical form factor for cell design includes cylindrical or prismatic. Large format prismatic cells are of particular interest for applications such as electric vehicles.

The limitations associated with current electrode fabrication process include: electrode surface roughness is not well controlled; a rough, localized surface can cause shorting between electrodes during battery operation, leading to rapid release of energy and thus serious safety issues; the edges of the electrode after the split process can be rough and cause edge shorting issue when sheets of electrodes are stacked together in prismatic battery cells; quality control of large format Li-ion battery is challenging—large format cells have a battery width around 10 cm or larger, while thermal runaway often starts in a microscopic process, which can happen in the middle of electrode due to impurities (which may lead to localized Li dendrite formation), roughness, localize heating, etc.

In one embodiment, a nano- or micro-particle spraying process is used to fabricate electrodes for Li-ion batteries, in particular for large format batteries. In certain embodiments, during the electrode fabrication process, functionality can be included to enhance the electrode performance. Functionalities, such as power electronics, thermistors, or pressure MEMS, can be formed through printed circuit type of processes, prior to the coating of electrode materials.

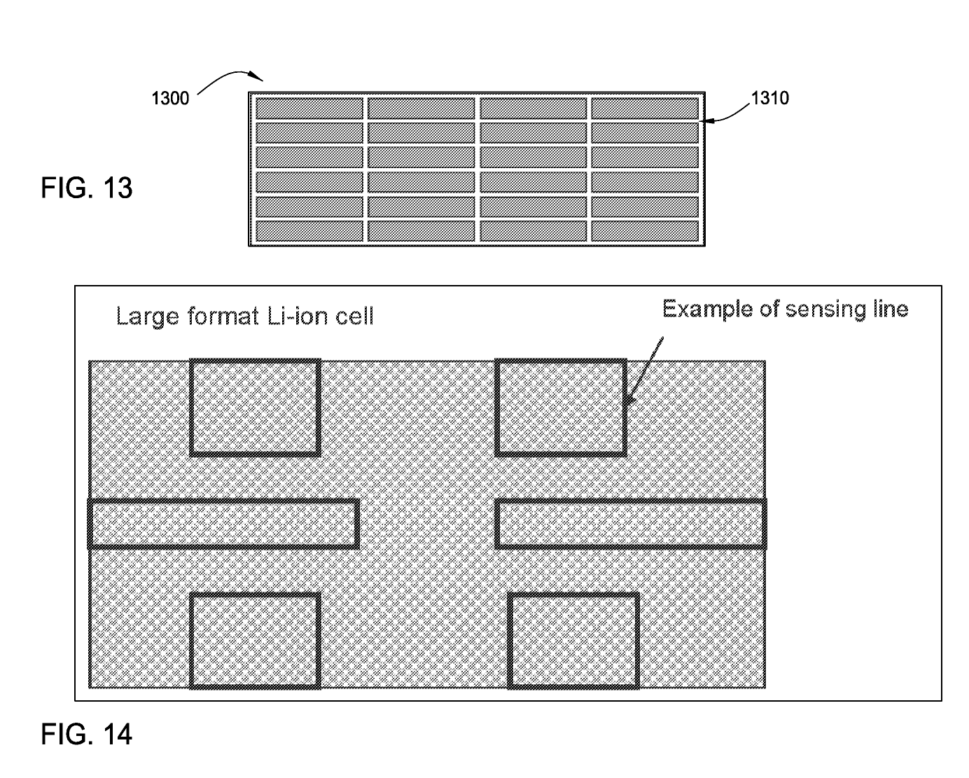

Advantageously, the process can be carried out in large format equipment to reduce the cost. The electrode foils 1300 are then divided to form electrodes for individual batteries, as shown in FIG. 13. The space in FIG. 13 can be formed using sacrificial printing lines 1310, which are removed after the coating process and leaving well-defined electrode edges.

The large scale spraying process reduces manufacturing costs. Additionally, the surface of electrode is smoother and better controlled than the current slurry coating process. A systematic pattern can be introduced to address the current process weakness. Functionality can be included in the printing or spraying process. Those additional processes to introduce functionalities can be processed using particle printing or deposition, to form “smart batteries” as shown in FIG. 14.

Examples of the Functionalities that can be Included:

(Improved quality, improved reliability): In one embodiment, a sacrificial pattern may be included to intentionally leave space, such as lines or micro-size vacancies, to allow better electrolyte penetration or to accommodate volume change during battery operation. The sacrificial pattern can also allow edge engineering in the prismatic cell and reduce edge shorting concerns.

(Improved performance) In one embodiment, built-in interconnects, such as Cu nanoparticle, Ag, ZnO or carbon particle, can be printed or deposited in a periodic pattern to enhance the Li-ion transport rate because of improved electronic conductivity.

(Improved safety) In one embodiment, built-in thermal runaway sensing: materials with non-linear response to voltage, current, pressure or temperature, can be used to detect the state of battery, and send signals to the battery controller for actions.

Multi-component electrodes: 2 or more types of electrode materials can be introduced simultaneously, either to stabilize the electrode crystalline structure (such as using L₂MnO₃ to stabilize LiMnO₂), change interface behavior (such as reduce SEI formation), or to tune the cell voltage (such as LiMnPO₄, LiFePO₄).

Nanoparticles, such as LiFePO₄, LiCoO₂, LiTiₓO_{y}, LiNiMnAlO₂, LiMn₂O₄, are commonly used in Li-ion batteries. The particle size is typically in the range of 30 nm to several hundred nm, depending on the material properties. Smaller particular size is desirable for materials with low conductivity. In such cases, nano-size particles are found to enhance the rate performance of batteries (i.e., faster Li-ion transport). In certain embodiments, in order to improve inter-particle contact and increase density, the nanoparticles are intentionally agglomerated to form secondary particles in the range of sub-micron to tens of micro. The secondary particles are mixed in slurry with a binder and conductor additive and coated as blanket films onto the current collector foils.

### Example

The following hypothetical non-limiting examples are provided to further illustrate embodiments described herein. However, the examples are not intended to be all inclusive and are not intended to limit the scope of the embodiments described herein.

An electrode particle solution was prepared by mixing particles and solvent. Additional binder, surfactant, or additive may be included as part of the solution. The particle size can be in the nano-range (i.e., primary particles), or micron-range (i.e., secondary particles).

The solution mixtures are prepared for spraying as a high viscosity mixture. Exemplary solutions include: The first solution comprises LiMn₂O₄ (or LiFePO₄, LiMnPO₄, LiNiMnAlO₂, etc.) nanoparticles, solvent and binder to form active part of electrode. The second solution comprises organic polymer, as sacrificial space divider. The third solution contains ZnO (or Cu, carbon, etc.) nanoparticles for forming interconnects.

The electrode with the desired numbers of elements (i.e., number of solutions) are either coated simultaneously or separately to form the desired pattern. In one embodiment, the desired thickness ranges from about 0.5 to about 100 um. In one embodiment the droplet size used in the spray can be in the range from about 1 to about 1,000 picoliter (i.e., 10 um-100 um diameter for a spherical droplet). The droplet size, wetting properties and number of printing passes control the final electrode height. The functional material can alternatively be deposited using either PVD (evaporation, sputtering), electrochemical deposition or CVD processes. A mask may be used to block areas where deposition is not desired.

Subsequent removal of the one or more printed materials may be performed, such as removal of sacrificial space forming materials. Subsequent annealing may be performed, to connect the nanoparticles through a sintering process, to drive out solvent or to reduce moisture. In one embodiment, the desired annealing temperature ranges from about 70° C. to about 700° C., depending on the solution material. In certain embodiment, multi-step annealing may be beneficial. In one embodiment, the annealing may be an atmospheric rapid thermal annealing process to reduce the annealing time required. Subsequent mechanical pressing may be performed to further densify the electrode, or smooth out the electrode surface.

While the foregoing is directed to embodiments of the present invention, other and further embodiments of the invention may be devised without departing from the basic scope thereof, and the scope thereof is determined by the claims that follow.

1. A lithium-ion battery having an electrode structure, comprising:
an anode stack, comprising:
an anodic current collector; and
an anode structure formed over a first surface of the anodic current collector;
a cathode stack, comprising:
a cathodic current collector; and
a cathode structure formed over a first surface of the cathodic current collector; and
an integrated separator formed between the anode stack and the cathode stack comprising:
a first ceramic layer;
a second ceramic layer; and
a polymer material layer deposited between the first ceramic layer and the second ceramic layer.

2. The lithium-ion battery of claim 1, wherein the first ceramic layer contacts a surface of the anode structure and the second ceramic layer contacts a surface of the cathode structure.

3. The lithium-ion battery of claim 1, wherein the first ceramic layer and the second ceramic layer each individually comprise ceramic particles selected from the group of: Pb(Zr,Ti)O₃ (PZT), Pb₁₋ₓLaₓZr_{1-y}Ti_{y}O₃ (PLZT, x and y are independently between 0 and 1), PB(Mg₃Nb_{2/3})O₃—PbTiO₃ (PMN-PT), BaTiO₃, HfO₂ (hafnia), SrTiO₃, TiO₂ (titania), SiO₂ (silica), Al₂O₃ (alumina), ZrO₂ (zirconia), SnO₂, CeO₂, MgO, CaO, Y₂O₃ and combinations thereof.

4. The lithium-ion battery of claim 3, wherein the first ceramic layer and the second ceramic layer each individually further comprise a binder selected from polyvinylidene fluoride (PVDF), carboxymethyl cellulose (CMC), and styrene-butadiene (SBR).

5. The lithium-ion battery of claim 1, wherein the cathode structure is a porous structure comprising a cathodically active material selected from the group comprising: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

6. The lithium-ion battery of claim 1, wherein the polymer material layer comprises a series of polymer lines with interspersed channels for transporting electrolyte formed in between adjacent polymer lines.

7. The lithium-ion battery of claim 6, wherein each polymer line has a width of between about 0.5 μm and about 10 μm.

8. The lithium-ion battery of claim 7, wherein the polymer material layer has a height between about 1 μm and about 10 μm.

9. The lithium-ion battery of claim 6, wherein the polymer material layer has a porosity between about 40% to about 80% as compared to a solid film formed from the same material and the first and second ceramic layer individually have a porosity between about 40% to about 60% as compared to a solid film formed from the same material.

10. The lithium-ion battery of claim 6, wherein the series of polymer lines comprises:
high melting temperature polymer lines comprising a first polymer material having a melting temperature greater than 200° C.; and
low melting temperature polymer lines comprising a second polymer material having a melting temperature less than 140° C. such that during thermal runaway, the low melting temperature polymer lines are melted and fused together, reducing porosity in the layer and thus slowing Li-ion transport and the associated electrochemical reactions.

11. The lithium-ion battery of claim 6, wherein each line of the series of polymer lines comprises:
a co-polymer comprising:
a first polymer material having a high melting temperature (Tₘ) greater than 200° C.; and
a second polymer material having a low melting temperature less than 140° C. such that during thermal runaway, the low melting temperature polymer lines are melted and fused together, reducing porosity in the layer and thus slowing Li-ion transport and the associated electrochemical reactions.

12. A method of forming an electrode structure comprising:
forming a first electrode structure; and
electrospraying a first ceramic separator directly onto a surface of the first electrode structure.

13. The method of claim 12, wherein the first ceramic separator comprises ceramic particles selected from the group comprising: Pb(Zr,Ti)O₃ (PZT), Pb₁₋ₓLaₓZr_{1-y}Ti_{y}O₃ (PLZT, x and y are independently between 0 and 1), PB(Mg₃Nb_{2/3})O₃—PbTiO₃ (PMN-PT), BaTiO₃, HfO₂ (hafnia), SrTiO₃, TiO₂ (titania), SiO₂ (silica), Al₂O₃ (alumina), ZrO₂ (zirconia), SnO₂, CeO₂, MgO, CaO, Y₂O₃ and combinations thereof.

14. The lithium-ion battery of claim 13, wherein the ceramic separator further comprises a binder selected from polyvinylidene fluoride (PVDF), carboxymethyl cellulose (CMC), and styrene-butadiene (SBR).

15. The method of claim 12, further comprising:
depositing a polymer material over the ceramic separator.

16. The method of claim 15, further comprising:
forming a second electrode structure;
electrospraying a second ceramic separator directly onto a surface of the second electrode structure; and
joining the first electrode structure and the second electrode structure to form a battery cell with an integrated separator comprising the first ceramic separator, the second ceramic separator and the polymer material positioned therebetween.

17. The method of claim 15, wherein the polymer material is deposited as a series of polymer lines with interspersed channels for transporting electrolyte formed in between adjacent polymer lines.

18. The method of claim 17, wherein the polymer material is deposited using an inkjet process.

19. The method of claim 17, wherein each line of the series of polymer lines comprises:
a co-polymer comprising:
a first polymer material having a high melting temperature (Tₘ) greater than 200° C.; and
a second polymer material having a low melting temperature less than 140° C. such that during thermal runaway, the low melting temperature polymer lines are melted and fused together, reducing porosity in the layer and thus slowing Li-ion transport and the associated electrochemical reactions.

20. A substrate processing system for processing an integrated separator over a flexible conductive substrate, comprising:
a first spray coating chamber configured to deposit a first portion of a ceramic separator over the flexible conductive substrate;
a second spray coating chamber configured to deposit a second portion of the ceramic separator over the over the flexible conductive substrate;
an inkjet chamber configured to deposit a polymer material layer over the ceramic separator; and
a substrate transfer mechanism configured to transfer the flexible conductive substrate among the chambers, comprising:
a feed roll disposed out side a processing volume of each chamber and configured to retain a portion of the flexible conductive substrate within the processing volume of each chamber; and
a take up roll disposed out side the processing volume and configured to retain a portion of the flexible conductive substrate, wherein the substrate transfer mechanism is configured to activate the feed rolls and the take up rolls to move the flexible conductive substrate in and out each chamber, and hold the one or more flexible conductive substrates in the processing volume of each chamber.
